(19) United States
(12) Patent Application Publication
(10) Pub. No.: US 2026/0247322 A1
(43) Pub. Date: Aug. 20, 2026

(54) METHOD AND APPARATUS FOR CONNECTION RESTORING IN NON-TERRESTRIAL NETWORKS

(71) Applicant: Lenovo (Beijing) Limited, Beijing (CN)

(72) Inventors: Min Xu, Beijing (CN); Lianhai Wu, Beijing (CN); Jing Han, Beijing (CN); Jie Shi, Beijing (CN); Ran Yue, Beijing (CN); Haiming Wang, Beijing (CN); Jie Hu, Beijing (CN)

(73) Assignee: Lenovo (Beijing) Limited, Beijing (CN)

(21) Appl. No.: 18/275,314

(22) PCT Filed: Feb. 4, 2021
(86) PCT No.: PCT/CN2021/075280

§ 371 Date: Aug. 1, 2023

(51) Int. Cl. H04W 64/00; H04W 24/08; H04W 76/20

(52) U.S. Cl. CPC H04W 64/00; H04W 24/08; H04W 76/20

(57) ABSTRACT

A method and an apparatus for connection restoring in non-terrestrial networks are provided. The method may be performed by a UE. The method includes receiving, from a first serving base station (BS), a coverage restoring information when the UE is connected to a wireless network via the first serving BS, wherein the coverage restoring information is associated with a next serving BS, for reconnecting the UE to the wireless network via the next serving BS; and reconnecting to the wireless network via the next serving BS following an interruption in the coverage of the wireless network, based on the coverage restoring information as received before the interruption in the coverage of the wireless network.

### TECHNICAL FIELD

Embodiments of the present disclosure generally relate to wireless communication technology, especially to a method and apparatus for non-terrestrial networks (NTNs).

### BACKGROUND

Non-terrestrial networks (NTN) may refer to networks, or segments of networks, using an airborne or space-borne vehicle to embark an NTN payload. A NTN payload may perform the desired communication function of the satellite (e.g., HAPS) between the service and the feeder link. A NTN payload may be embarked on board space/airborne vehicle. High Altitude Platform Station (HAPS) may refer to airborne vehicle embarking the NTN payload placed at an altitude between 8 and 50 km. The satellite in NTN can be a geostationary earth orbiting (GEO) satellite with fixed location with respect to the Earth, or a low earth orbiting (LEO) satellite orbiting around the Earth. In 3GPP Rel-17 NTN using new radio (NR) air interface is discussed in the work item “Solutions for NR to support NTN” and NTN using long-term evolution (LTE) air interface for internet of things (IoT) user equipment (UE) is discussed in the study item “Study on NB-IoT/eMTC support for NTN.” “NB-IoT/eMTC” stands for “narrow band-IoT/enhanced machine type communication.”

In the discussions for “Study on NB-IoT/eMTC support for NTN” scenarios (R1-2008868 and R2-2011228), two satellite service providers (Satelliot and Gatehouse) proposed to include microsatellite platforms (as known as Cube satellites) with limited size and power and low-density constellations. Cube satellites may have restricted link budget and discontinuous service link coverage, and UEs may endure long periods of time without being able to detect a satellite cell. The schemes for employing Cube satellites should be contemplated, and will be discussed in RAN1 #104e.

### SUMMARY OF THE APPLICATION

For NTN, the discontinuous service link coverage may happen in space domain and/or time domain due to the movement of satellite and/or UE. It may lead to additional and unnecessary power consumption. However, power consumption is critical for IoT devices. The regular trajectory of NTN platforms (e.g., LEO satellites) as well as the low mobility of IoT devices provide room for enhancement. The present disclosure provides novel methods and apparatus for discontinuous coverage in NTN.

Some embodiments of the present disclosure provide a method performed by a user equipment (UE). The method comprises: receiving, from a first serving base station (BS), a coverage restoring information when the UE is connected to a wireless network via the first serving BS; and reconnecting to the wireless network via the next serving BS following an interruption in the coverage of the wireless network, based on the coverage restoring information as received before the interruption in the coverage of the wireless network. The coverage restoring information is associated with a next serving BS, for reconnecting the UE to the wireless network via the next serving BS.

Some embodiments of the present disclosure provide a method performed by a first base station (BS). The method comprises: transmitting, to a next serving BS and/or a core network entity, a first request for a first coverage restoring information associated with the next serving BS; receiving the first coverage restoring information associated with the next serving BS; and transmitting a second coverage restoring information to a user equipment (UE) based on the first coverage restoring information when the UE is connected to a wireless network via the first serving BS. The second coverage restoring information is associated with the next serving BS for reconnecting the UE to the wireless network via the next serving BS, following an interruption in a coverage of the wireless network.

Some embodiments of the present disclosure also provide a user equipment (UE), comprising: at least one processor; and at least one transceiver coupled to the at least one processor. the at least one processor is configured to: receive, via the at least one transceiver, a coverage restoring information from a first serving base station (BS) when the UE is connected to a wireless network via the first serving BS, wherein the coverage restoring information is associated with a next serving BS, for reconnecting the UE to the wireless network via the next serving BS; and reconnect, via the at least one transceiver, to the wireless network through the next serving BS following an interruption in the coverage of the wireless network, based on the coverage restoring information as received before the interruption in the coverage of the wireless network.

Some embodiments of the present disclosure also provide a first base station (BS), comprising: at least one processor; and at least one transceiver coupled to the at least one processor. The at least one processor is configured to: transmit, to a second BS and/or a core network entity, a first request for a first coverage restoring information associated with the second BS via the at least one transceiver; receive the first coverage restoring information associated with the other BS; and transmit a second coverage restoring information to a user equipment (UE) based on the first coverage restoring information when the UE is connected to a wireless network via the first BS, wherein the second coverage restoring information is associated with the second BS, for reconnecting the UE to the wireless network via the second BS following an interruption in a coverage of the wireless network.

Embodiments of the present disclosure provide a technical solution for discontinuous coverage in an NTN. Accordingly, embodiments of the present disclosure can save unnecessary power consumption on UE side or reestablishment procedures.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present disclosure.

FIG. 2 is a schematic diagram illustrating a radio resource control (RRC) connecting scheme for coverage restoring according to some embodiments of the present disclosure.

FIG. 3 is a schematic diagram illustrating a RRC restoring scheme according to some embodiments of the present disclosure.

FIG. 4 is a schematic diagram illustrating a connection restoring scheme according to some embodiments of the present disclosure.

FIG. 5 is a schematic diagram illustrating transmissions of coverage interruption estimations according to some embodiments of the present disclosure.

FIG. 6 is a schematic diagram illustrating transmissions of coverage interruption estimations according to some embodiments of the present disclosure.

FIG. 7 is a schematic diagram illustrating transmissions of coverage interruption estimations according to some embodiments of the present disclosure.

FIG. 8 is a flowchart of a method according to some embodiments of the present disclosure.

FIG. 9 is a flowchart of another method according to some embodiments of the present disclosure.

FIG. 10 is a simplified block diagram of an apparatus for communication according to some embodiments of the present disclosure.

### DETAILED DESCRIPTION

The detailed description of the appended drawings is intended as a description of the currently preferred embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

Also, the use of the expression “A and/or B” means any one of the following: “A” alone or “B” alone; or both “A” and “B” together.

Reference will now be made in detail to some embodiments of the present disclosure, examples of which are illustrated in the accompanying drawings. To facilitate understanding, embodiments are provided under specific network architecture and new service scenarios, such as 3GPP 5G New Radio (NR), 3GPP long-term evolution (LTE) Release 8 and so on. Persons skilled in the art know very well that, with the development of network architecture and new service scenarios, the embodiments in the present disclosure are also applicable to other similar technical problems.

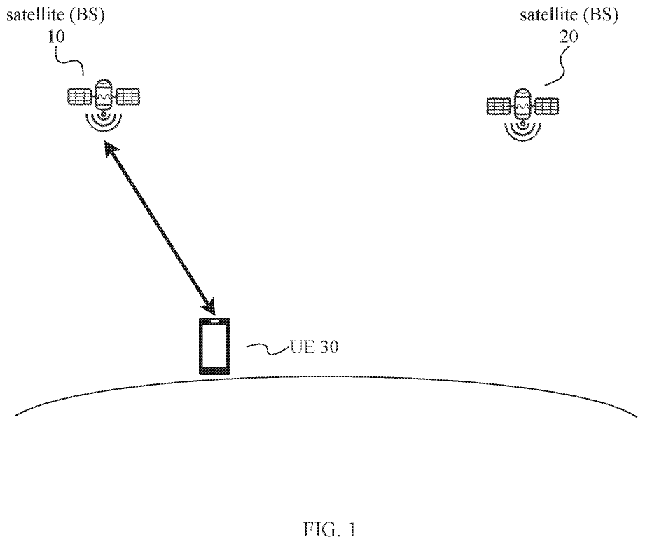

FIG. 1 is a schematic diagram illustrating an exemplary wireless communication system according to some embodiments of the present disclosure.

FIG. 1 shows communications between UE and satellites (e.g., base station, BS). FIG. 1 shows the BS 10, BS 20, and UE 30 for illustrative purpose. The UE 30 may be under the coverage of the BS 10. As shown in FIG. 1, the BS 10 may be in communication with the UE 30. In some embodiments, the UE 30 may be radio resource control (RRC) connected with the BS 10. The UE 30 may be connected with the BS 10 on the RRC layer. Data blocks or data packets may be transmitted and/or received between the BS 10 the UE 30. Data blocks or data packets may be transmitted and/or received in resource blocks between the BS 10 the UE 30.

For example, the wireless communication system in FIG. 1 may be compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G NR network, a satellite communications network, a non-terrestrial network, a high altitude platform network, and/or other communications networks. In some embodiments, the wireless communication system in FIG. 1 may be compatible with NB-IoT/eMTC for NTN.

In some embodiments, the BS 10 and BS 20 may be referred to as a NodeB, a base unit, a base, an access point, an access terminal, a macro cell, an enhanced Node B (eNB), a gNB, a Home Node-B, a relay node, a device, a remote unit, or by other terminology used in the art. A BS may be distributed over a geographic region. Generally, a BS is a part of a radio access network that may include one or more controllers communicably coupled to one or more corresponding core networks. In some embodiments, the BS 10 and BS 20 may be a geostationary earth orbiting (GEO) satellite with fixed location with respect to the Earth, or a low earth orbiting (LEO) satellite orbiting around the Earth.

The UE 30 may include computing devices such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, the UE 30 may include a portable wireless communication device, a smart phone, a cellular telephone, a flip phone, a device having a subscriber identity module, a personal computer, a selective call receiver, or any other device capable of transmitting and receiving communication signals on a wireless network. In some embodiments, the UE 30 may include wearable devices, such as smart watches, fitness bands, optical head-mounted displays, or the like. Moreover, the UE 30 may be referred to as a subscriber unit, a mobile, a mobile station, a user, a terminal, a mobile terminal, a wireless terminal, a fixed terminal, a subscriber station, a user terminal, or a device, or described with other terminology used in the art.

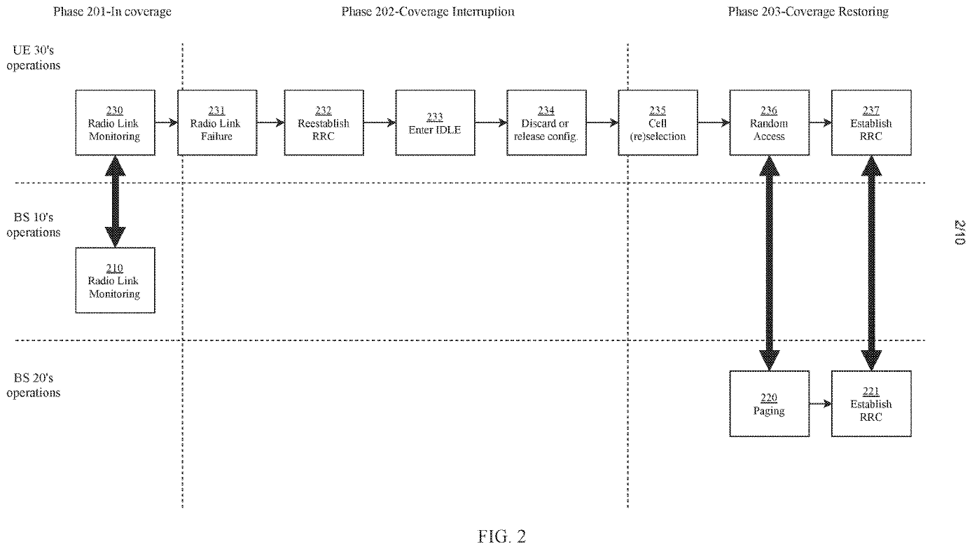

FIG. 2 is a schematic diagram illustrating a RRC connecting scheme for coverage restoring according to some embodiments of the present disclosure. In FIG. 2, coverage interruption may occur due to discontinuous coverage. In FIG. 2, the first row from the top may be directed to the operations of the UE 30; the second row from the top may be directed to the operations of the BS 10; the third row from the top may be directed to the operations of the BS 20. The embodiment of FIG. 2 may include three phases: phase 201 which may indicate the UE 30 is in coverage; phase 202 which may indicate coverage interruption occurs to the UE 30; and phase 203 which may indicate coverage restoring for the UE 30.

In the embodiment of FIG. 2, the UE 30 and the BS 10 are connected in phase 201. The UE 30 may be in CONNECTED state. The BS 10 may perform radio link monitoring (RLM) (e.g., operation 210). The UE 30 may perform RLM (e.g., operation 230). During RLM, the BS 10 and the UE 30 may be in communication. The UE 30 may detect radio link failure (RLF) (e.g., operation 231) when approaching the edge of discontinuous network coverage (e.g., the coverage of the BS 10).

When the UE 30 detect RLF (e.g., operation 231), it may be directed to the situation that the UE 30 may be disconnected from the BS 10. Phase 202 arrives when the UE 30 detects RLF. In operation 232, he UE 30 may try to find a suitable cell or a suitable BS to re-establish RRC connection. In operation 233, the UE 30 may transit or enter to IDLE state when the timer T301 expires due to coverage interruption (e.g., no suitable cell or BS is found). In operation 234, the UE 30 may discard or release connection configuration used for the BS 10.

In operation 235, the UE 30 may perform cell (which is associated with a BS) reselection. In operation 220, the BS 20, which may be able to serve the UE 30, may page the UE 30. In operation 236, the UE 30 may perform random access with the BS 20. In operation 237, the UE 30 may establish anew RRC connection with the BS 20. In operations 221, the BS 20 may establish a RRC connection with the UE 30. In the embodiment of FIG. 2, the BS 10 may be referred to as the serving satellite or the serving satellite for the UE 30; the BS 20 may be referred to as the next serving satellite or the next serving satellite for the UE 30 with respect to the BS 10. In the embodiment of FIG. 2, the RLM, RLF detection, and RRC re-establishment may be unnecessary.

From the perspective of discontinuous coverage, phase 202 may remain for a significant time period. Thus, some procedures in FIG. 2 may be omitted for the sake of power saving or reducing signalling overhead.

It is observed that the connected mobility mechanisms designed for continuous coverage cannot be applied to discontinuous scenario as UE will not directly enter IDLE state when coverage interruption occurs. To avoid unnecessary procedures and minimize impact of coverage interruption, the key issues include how to make the source cell aware of the target cell after coverage interruption (e.g., at least one of cell identity of the target cell, when the target cell is available, and where the target cell is available), and how to guarantee the validity of the RRC configuration for the target cell after coverage interruption, especially if UE enters IDLE state.

If the network side or the UE may roughly estimate the coverage interruption referring to satellite ephemeris or satellite deployment, the UE may directly moving to an IDLE or INACTIVE state without operations 230-232. However, at network side, it may not be easy to determine the appropriate timing or location at which coverage interruption occurs without UE location and/or motion information. Therefore, the network side (e.g., the BSs 10 and 20 and core network 40) may not have accurate information related to coverage interruption so as to move the UE 30 from the CONNECTED state to the IDLE or INACTIVE state (or disable unnecessary RLM/RLF) in discontinuous coverage scenario.

Furthermore, considering that the configurations used for the CONNECTED state may be released or discarded (e.g., operation 234) when the UE 30 enters IDLE state, the UE 30 may have to initiate random access (e.g., operation 236) and establish anew RRC connection when the coverage restores (e.g., operation 237). For example, the coverage may restore when a new cell belonging to the different satellites (i.e., the BSs 10 and 20 are different satellites) is available again after the coverage interruption occurs. In some embodiments, the coverage may restore when a new cell belonging to the same satellite (i.e., the BSs 10 and 20 are an identical satellite) is available again after the coverage interruption occurs. Therefore, it may be not necessary for the UE 30 to initiate random access and establish a new RRC connection when coverage restores in discontinuous coverage scenario.

At least one objective of the present disclosure is to provide novel methods to save unnecessary power consumption and unnecessary signalling overhead for the UE 30. Considering the coverage interruption (in space domain and/or in time domain) due to discontinuous coverage:
I. The UE (e.g., the UE 30) and the network (e.g., the BSs 10 and 20, and the core network 40) may exchange the coverage interruption estimations (e.g., the area/location and/or time period at which the coverage interruption occurs). The exchange may be UE reporting the coverage interruption and possibly network performing correction to the reported coverage interruption. Alternatively, the exchange may be network indicating the coverage interruption and possibly UE or another entity in the network performing correction to the indicated coverage interruption.
II. Based on the coverage interruption estimation, the network (e.g., the BSs 10 and 20, and the core network 40) may indicate coverage restoring information (e.g., the information of the next serving cell and other necessary information) to the UE. The coverage restoring information may be retained at the UE when entering the IDLE state.
III. Based on the coverage interruption estimation, the network (e.g., the BSs 10 and 20, and the core network 40) may prepare for coverage interruption and/or coverage restoring. The preparation may include information exchange between BSs or between BS and core network.

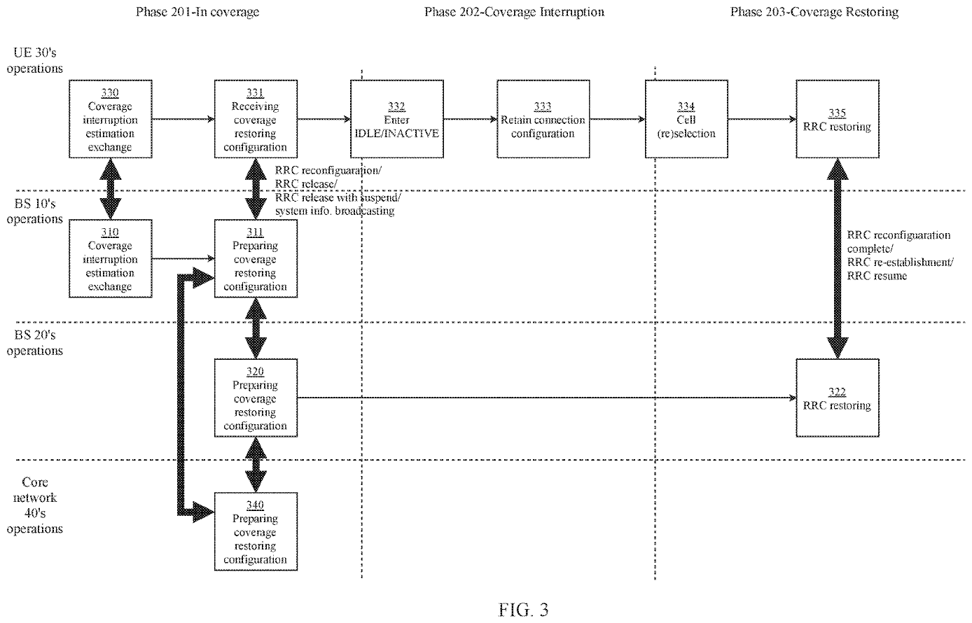

FIG. 3 is a schematic diagram illustrating a RRC restoring scheme according to some embodiments of the present disclosure. In FIG. 3, coverage interruption may occur due to discontinuous coverage. In FIG. 3, the first row from the top may be directed to the operations of the UE 30; the second row from the top may be directed to the operations of the BS 10; the third row from the top may be directed to the operations of the BS 20; the fourth row from the top may be directed to the operations of the core network 40. The embodiment of FIG. 3 may include three phases: phase 201 which may indicate the UE 30 is in coverage; phase 202 which may indicate coverage interruption occurs to the UE 30; and phase 203 which may indicate coverage restoring for the UE 30.

In the embodiment of FIG. 3, the UE 30 and the BS 10 are connected in phase 201. The UE 30 may be in CONNECTED state. In operation 330, the UE 30 may transmit or receive a coverage interruption estimation with the BS 10. In operation 310, the BS 10 may transmit or receive a coverage interruption estimation with the UE 30.

In operation 311, the BS 10 may prepare coverage restoring information for the UE 30. In operation 311, the BS 10 may transmit a coverage interruption estimation to the BS 20 (which may be the next serving satellite for the UE 30) and to the core network 40. In operation 311, the BS 10 may receive corresponding information from the BS 20 (which may be the next serving satellite for the UE 30) or from the core network 40.

In operation 320, the BS 20 may prepare coverage restoring information for the UE 30. In operation 320, the BS 20 may receive a coverage interruption estimation from the BS 10 (which may be the current serving satellite for the UE 30) and from the core network 40. In operation 311, the BS 20 may transmit corresponding information to the BS 10 (which may be the current serving satellite for the UE 30) and to the core network 40.

In operation 340, the core network 40 may prepare coverage restoring information for the UE 30. In operation 340, the core network 40 may receive a coverage interruption estimation from the BS 10 (which may be the current serving satellite for the UE 30) and from the BS 20 (which may be the next serving satellite for the UE 30). In operation 340, the core network 40 may transmit corresponding information to the BS 10 (which may be the current serving satellite for the UE 30) and to the BS 20 (which may be the next serving satellite for the UE 30).

In operation 311, the UE 30 may receive coverage restoring information from the BS 10. The coverage restoring information received by the UE 30 may be transmitted through RRC signalling (e.g., RRC reconfiguration, RRC release, or RRC release with suspend) or system information broadcasting. The coverage restoring information received by the UE 30 may be retained when the UE 30 changes the state to IDLE or INACTIVE state.

In operation 332, when being out of the coverage of the BS 10 (e.g., during the transition between the phases 201 and 203), the UE 30 may change the state to the IDLE or INACTIVE state. In some embodiments, after being out of the coverage of the BS 10, the UE 30 may not detect radio link failure (RLF) because the UE 30 may know when or where the UE 30 is out of the coverage of the BS 10. In operation 333, the UE 30 may retain the connection configuration used between the BS 10 and the UE 30. In operation 333, the UE 30 may retain the coverage restoring information received from the BS 10. The retained connection configuration used between the BS 10 and the UE 30 may be used for restoring coverage from the BS 20 in phase 203. The retained coverage restoring information may be used for restoring coverage from the BS 20 in phase 203.

In operation 334, when being within the coverage of the BS 20 (e.g., during the transition between the phases 202 and 203), the UE 30 may perform cell reselection or cell selection. In some embodiments, the UE 30 may know the location (or area) or the time at which the cell reselection (or cell selection) should be performed because the UE 30 may know when or where the UE 30 is within the coverage of the BS 20 (i.e., the next serving satellite). In operation 335, the UE 30 may perform RRC restoring with the BS 20 (i.e., the next serving satellite). In operation 322, the UE 30 may perform RRC restoring with the UE 30 (i.e., the current served UE). The RRC restoring between the UE 30 and the BS 20 may be performed through RRC signalling (e.g., RRC reconfiguration complete, RRC re-establish, or RRC resume).

Some estimating methods for coverage interruption estimations are considered. The UE 30 may generate a coverage interruption estimation (e.g., including estimated coverage interruption area and/or time period) based on the UE 30's location and the information provided by the network (e.g., satellite ephemeris or coverage). The UE 30 may report its coverage interruption estimation to the network e.g., the BS 10) using RRC signalling in the CONNECTED state.

In some embodiments, the network (e.g., the BS 10) may configure or request the UE 30 to report a coverage interruption estimation (e.g., including estimated coverage interruption area and/or time period) through the measurement configuration. The request of coverage interruption estimation from the BS 10 may be triggered by received signal strength, system time, the UE 30's location, or the determination that coverage interruption may be going to occur. In response to the request, the UE 30 may report its coverage interruption estimation in the measurement report. The coverage interruption estimation from the UE 30 may be also triggered by received signal strength, system time, or the UE 30's location.

In other embodiments, the network (e.g., the BS 10) may generate a coverage interruption estimation (e.g., including estimated coverage interruption area and/or time period) based on its deployment (e.g., satellite ephemeris or coverage) and possible location of the UE 30. The network may indicate its coverage interruption estimation to the UE 30 in the CONNECTED state through RRC signalling.

Before coverage interruption occurs, some operations of the UE 30 may be considered. In some embodiments, the UE 30 may receive, from the network, a configuration or a request for reporting a coverage interruption estimation. The UE 30 may be triggered to report its coverage interruption estimation based on the configuration or the request from the network. In some embodiments, the UE 30 may receive a coverage interruption estimation from the network. The UE 30 may be triggered to report its coverage interruption estimation based on the receipt of the coverage interruption estimation from the network. In some embodiments, the UE 30 may be triggered to report its coverage interruption estimation based on the received signal strength, the system time, and the UE 30's location. In some embodiments, the UE 30 may be triggered to reporting its coverage interruption estimation periodically. In some embodiments, the UE 30 may be triggered to reporting its coverage interruption estimation if it is determined that coverage interruption may be going to occur.

Before coverage interruption occurs, some operations of the UE 30 may be considered. The UE 30 may receive coverage restoring information from the network (e.g. the BS 10). The coverage restoring information may be transmitted by the network through RRC reconfiguration signalling (which is used for handover), RRC release signalling, RRC release with suspend signalling, or system broadcasting.

The UE 30 may retain coverage restoring information from the network when changing the state to the IDLE or INACTIVE state. The retained coverage restoring information may be used for coverage restoring between the UE 30 and the next serving cell (e.g., the cell associated with the BS 20). The UE 30 may retain the network configuration of the current connection (e.g., between the UE 30 and the BS 10) when changing the state to the IDLE or INACTIVE state. The retained network configuration may be used for coverage restoring between the UE 30 and the next serving cell (e.g., the cell associated with the BS 20).

After coverage interruption occurs, some operations of the UE 30 may be considered. The UE 30 may restore the RRC connection with the next serving cell (e.g., the cell associated with the BS 20) using the coverage restoring information through RRC reconfiguration complete signalling, RRC re-establishment signalling, or RRC resume signalling.

After coverage interruption occurs, the UE 30 may try to restore RRC connection on at least one of the conditions that:
(1) a pre-determined time, as indicated or estimated before coverage interruption, arrives;
(2) the UE 30 is at a pre-determined location as indicated or estimated before coverage interruption;
(3) system information is received from the next serving cell (e.g. the cell associated with the BS 20) as indicated or estimated before coverage interruption;
(4) the UE 30 select/reselects the next serving cell (e.g. the cell associated with the BS 20) as indicated or estimated before coverage interruption;
(5) the UE 30 is paged by the next serving cell (e.g. the cell associated with the BS 20) as indicated or estimated before coverage interruption.

After coverage interruption occurs, the UE 30 may omit random access with the next serving cell (e.g., the cell associated with the BS 20) as indicated or estimated before coverage interruption. For example, if the UE 30 may pre-compensate the timing advance to the next serving cell (e.g., the cell associated with the BS 20) based on the ephemeris information of the next serving satellite (e.g., the BS 20), the UE 30 may omit random access with the next serving cell (e.g., the cell associated with the BS 20).

Some operations during the preparation of the coverage restoring information at the network side may be considered. The serving BS (e.g., the BS 10) may indicate the coverage interruption estimation to the next serving BS (e.g., the BS 20). The serving BS (e.g., the BS 10) may request information and/or resources from the next serving BS (e.g., the BS 20) for UE's coverage restoring. The serving BS (e.g., the BS 10) may indicate the coverage interruption estimation to the core network (e.g., the core network 40). The serving BS (e.g., the BS 10) may request the core network (e.g., the core network 40) to retain configuration associated with the UE (e.g., UE context, radio bearer, PDU session or PDN connection).

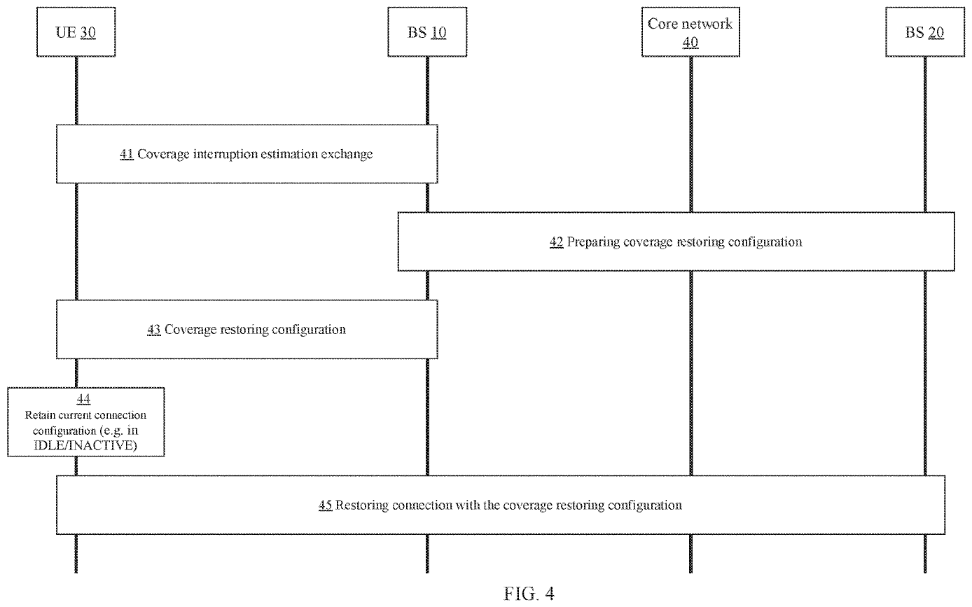

FIG. 4 is a schematic diagram illustrating a coverage restoring scheme according to some embodiments of the present disclosure. In the embodiment of FIG. 4, the UE 30 may be connected to the BS 10 at beginning; and then coverage interruption may occur between the UE 30 and the BS 10. After coverage interruption, the UE 30 may perform coverage restoring with the BS 20.

In operation 41, the coverage interruption estimation may be transmitted and received between the UE 30 and the BS 10. From the UE 30 to the BS 10, the coverage interruption estimation may include at least one of: (1) identity of a next serving BS/cell after coverage interruption; (2) an area or location where the network coverage may interrupt (i.e. an area or location where the serving cell may be unavailable); (3) an area or location where the network coverage may restore (i.e. an area or location where the next serving cell may be available); (4) a time when the network coverage may interrupt (i.e. a time when the serving cell may be unavailable); (5) a time when the next serving cell may be available); and (6) other information required by the network (e.g. the BSs 10 and 20 and the core network 40).

In operation 41, the coverage interruption estimation generated by the UE 30 may be based on at least one of: (1) the location of the UE 30; (2) the velocity of the UE 30; (3) the route of the UE 30; (4) the network deployment information (e.g., satellite ephemeris); and (5) the coverage interruption estimation from the network (e.g., the BSs 10 and 20 and the core network 40).

In operation 41, the coverage interruption estimation generated by the UE 30 may be transmitted through a dedicated signalling (e.g., RRC signalling including measurement report or minimized drive test (MDT) report).

In operation 41, the UE 30 may be triggered to generate or report the coverage interruption estimation by at least one of the conditions that:
(1) a configuration or request is received from the network (e.g. the BS 10) to report the coverage interruption estimation, in which the configuration or request may be transmitted through a dedicated signalling or broadcasting;
(2) a coverage interruption estimation is received from the network (e.g. the BS 10);
(3) a pre-determined or configured time arrives;
(4) a pre-determined or configured periodicity arrives;
(5) the UE 30 is at a pre-determined or configured location or area;
(6) the velocity of the UE 30 is above or below a pre-determined or configured threshold;
(7) the received signal strength is above or below a pre-determined or configured threshold; and
(8) it is determined the coverage interruption may be going to occur.

In operation 41, the network (e.g., the BS 10) may configure or request the UE 30 for reporting the coverage interruption estimation. The content of the configuration or request from the BS 10 to the UE 30 may include at least one of: (1) required information in the coverage interruption estimation from the UE 30 (e.g. the next BS/cell identity, the area or location where network coverage interrupt/restore, or the time when network coverage interrupt/restore); (2) trigger conditions for the UE 30 to report the coverage interruption estimation (e.g. immediately, periodically, or the conditions based on time, location, area, velocity, or received signal strength); (3) the coverage interruption estimation from the network (e.g. the BSs 10 and 20 and the core network 40).

In operation 41, the network (e.g., the BS 10) may configure or request the UE 30 for reporting the coverage interruption estimation through a dedicated signalling (e.g., RRC signalling, including measurement report configuration or MDT configuration) or system information broadcasting.

In operation 41, the network (e.g., the BS 10) may receive the coverage interruption estimation from the UE 30 through a dedicated signalling (e.g., RRC signalling including measurement report or MDT report).

In operation 42, the coverage restoring information may be prepared between the BSs 10 and 20 and the core network 40. In operation 42, the BS 10 may transmit a coverage interruption estimation to at least one of: (1) the BS 20 (the next serving BS as estimated by UE 30 or the network) through the Xn/X2 interface; and (2) the corresponding core network entity of the core network 40 e.g., the Access and Mobility Management Function (AMF) entity and/or the Mobility Management Entity (MME).

In operation 42, the BS 10 may transmit a request to the BS 20 for the coverage restoring information. The BS 20 may respond the coverage restoring information including at least one of: (1) identity of the next serving cell associated with the BS 20; (2) an area or location where the network coverage may restore (i.e. an area or location where the next serving cell associated with the BS 20 may be available); (3) a time when the network coverage may restore (i.e. a time when the next serving cell associated with the BS 20 may be available); and (4) other information required to access the next serving cell associated with the BS 20 (similar to the information of a handover command required to access target cell).

In operation 42, the BS 10 may transmit a request to the core network 40 for the coverage restoring information. The core network 40 may perform at least one of the following operations: (1) forwarding the request to the BS 20; (2) retaining the context of the UE 30 during the coverage interruption for restoring; and (3) retaining the non-access stratum (NAS) configuration of the UE 30 (e.g., data flow mapping, PDU session, EPC bearer, PDN connection) for restoring.

In operation 43, the coverage restoring information may be transmitted from the BS 10 to the UE 30. In operation 43, the coverage restoring information may be transmitted or received through a dedicated signalling (e.g., RRC signalling including RRC reconfiguration/release/release with suspend) or system information broadcasting.

In operation 43, the coverage restoring information transmitted by the BS 10 or received by the UE 30 may include at least one of following items: (1) identity of the next serving BS/cell (e.g. the BS 20/the cell associated with the BS 20) after coverage interruption; (2) an area or location where the network coverage may interrupt (i.e. an area or location where the serving cell may be unavailable); (3) an area or location where the network coverage may restore (i.e. an area or location where the next serving cell may be available); (4) a time when the network coverage may interrupt (i.e. a time when the serving cell may be unavailable); (5) a time when the network coverage may restore (i.e. a time when the next serving cell may be available); (6) indication of retaining the configuration (including the current connection configuration between the UE 30 and the BS 10 and the coverage restoring information) when changing states (e.g. IDLE or INACTIVE state); (7) other information required to access the next serving cell (similar to the information of a handover command required to access target cell).

In operation 44, the UE 30 may retain the configuration in CONNECTED state and other states (e.g., IDLE or INACTIVE state). The configuration retained by the UE 30 may include: (1) the current connection configuration between the UE 30 and the BS 10 and (2) the coverage restoring information from the BS 10

In operation 45, the UE 30 may restore the connection with the BS 20 using the coverage restoring information. In operation 45, the UE 30 may be triggered to restoring the connection on at least one of the conditions that:
(1) the time as configured in the coverage restoring information arrives;
(2) the UE 30 is at the location or area as configured in the coverage restoring information;
(3) system information is received from the next serving BS/cell as configured in the coverage restoring information (e.g. the BS 20 and the cell associated with the BS 20);
(4) the UE 30 selects/reselects the next serving BS/cell as configured in the coverage restoring information (e.g. the BS 20 and the cell associated with the BS 20); and
(5) the UE 30 is paged by the next serving BS/cell as configured in the coverage restore configuration (e.g. the BS 20 and the cell associated with the BS 20).

In operation 45, the UE 30 may transmit a request for restoring the connection through a dedicated signalling (e.g., RRC signalling, including RRC reconfiguration complete/re-establishment/resume).

In operation 45, the UE 30 may omit random access procedures to the next serving BS/cell as configured in the coverage restore configuration (e.g., the BS 20 and the cell associated with the BS 20). For example, if the UE 30 can pre-compensate the timing advance to the serving cell associated with the BS 20 based on the ephemeris information of the BS 20, the UE 30 may omit random access procedures. When the UE 30 omits random access procedures, the UE 30 may receive a rejection for restore from network due to timing misalignment.

In operation 45, the network (e.g., the BS 20) may receive a request for restoring the connection through a dedicated signalling (e.g., RRC signalling including RRC reconfiguration complete/re-establishment/resume).

In operation 45, the next serving BS (e.g., the BS 20) may accept or reject the request from the UE 10 for restoring the connection. For example, if the UE 30 omits random access, the BS 20 may transmit a rejection for restoring the connection due to timing misalignment.

In operation 45, the next serving BS (e.g., the BS 20) may initiate retrieval for the context of the UE or the status of the previous serving BS upon receiving the connection restoring request from UE 30.

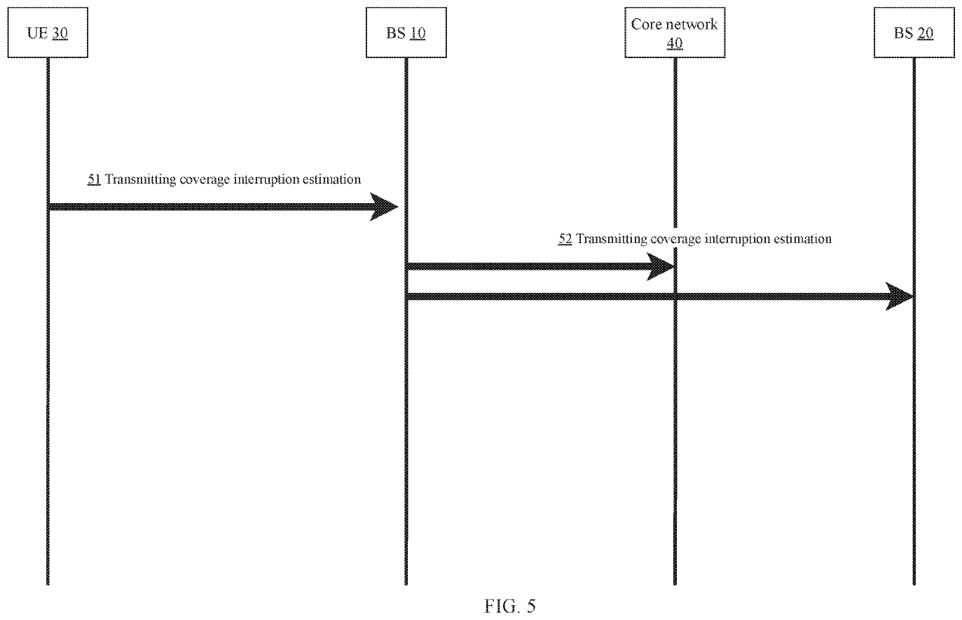

FIG. 5 is a schematic diagram illustrating transmissions of coverage interruption estimations according to some embodiments of the present disclosure. FIG. 5 shows operations 51 and 52. In operation 51, the UE 30 may actively determine that coverage interruption may occur. In operation 51, the UE 30 may transmit a coverage interruption estimation to the BS 10. In operation 51, the coverage interruption estimation from the UE 30 may be generated by the UE 30. Operation 51 may be a part of operation 41.

In operation 52, the BS 10 may transmit a coverage interruption estimation to the BS 20 and/or the core network 40. The coverage interruption estimation transmitted by the BS 10 may be identical to that received from the UE 30. The coverage interruption estimation transmitted by the BS 10 may be generated by the BS 10 based on the coverage interruption estimation from the UE 30 and the information stored in the BS 10. Operation 52 may be a part of operation 42.

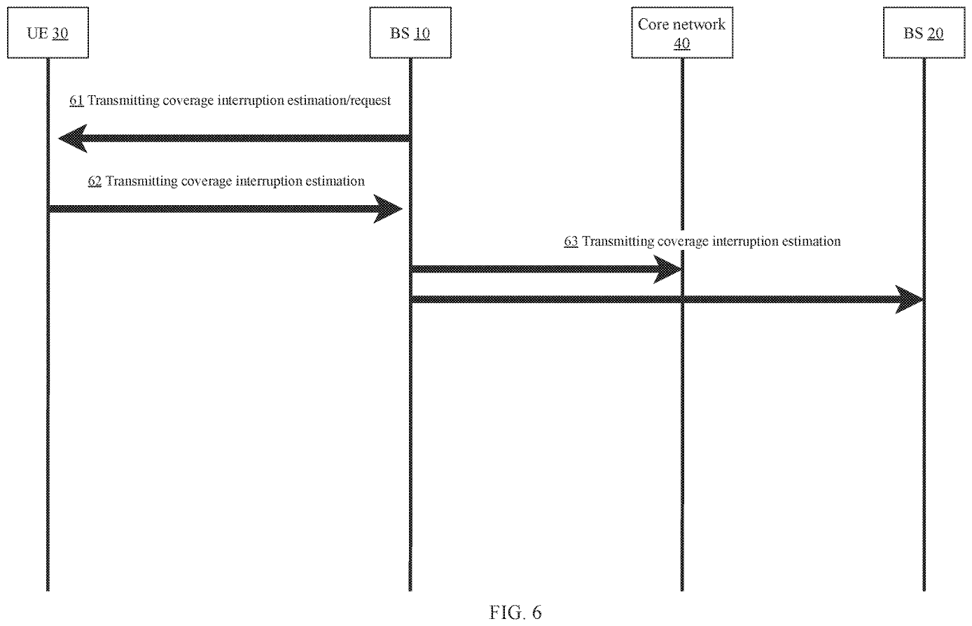

FIG. 6 is a schematic diagram illustrating transmissions of coverage interruption estimations according to some embodiments of the present disclosure. FIG. 6 shows operations 61, 62, and 63. In operation 61, the BS 10 may actively determine that coverage interruption may occur. In operation 61, the BS 10 may transmit a coverage interruption estimation to the UE 30. In operation 61, the BS 10 may transmit a request to the UE 30 for reporting the UE 30's coverage interruption estimation.

In operation 62, the UE 30 may determine that coverage interruption may occur based on the request or the coverage interruption estimation from the BS 10. In operation 62, the UE 30 may transmit a coverage interruption estimation to the BS 10. In operation 62, the UE 30 may transmit a coverage interruption estimation to the BS 10 if a trigger condition is met, in which the trigger condition may be configured by the UE 30, the BS 10, or both. In operation 62, the coverage interruption estimation from the UE 30 may be generated by the UE 30 based on the coverage interruption estimation from the BS 10 and the information stored in the UE 30. In operation 62, the coverage interruption estimation from the UE 30 may be generated by the UE 30 based on the information stored in the UE 30. Operations 61 and 62 may be a part of operation 41.

In operation 63, the BS 10 may transmit a coverage interruption estimation to the BS 20 and/or the core network 40. The coverage interruption estimation transmitted by the BS 10 may be identical to that received from the UE 30. The coverage interruption estimation transmitted by the BS 10 may be generated by the BS 10 based on the coverage interruption estimation from the UE 30 and the information stored in the BS 10. Operation 63 may be a part of operation 42.

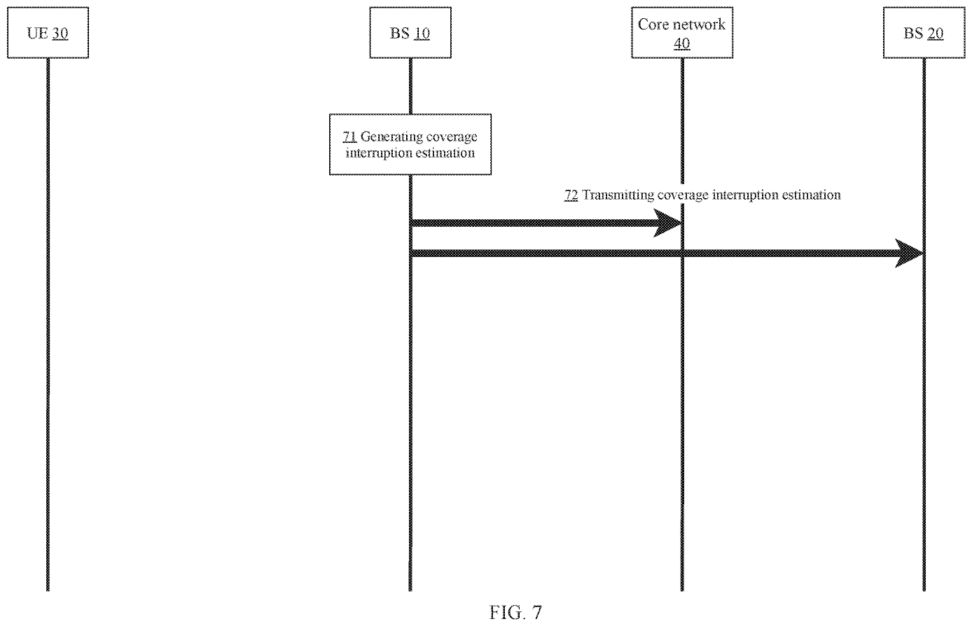

FIG. 7 is a schematic diagram illustrating transmissions of coverage interruption estimations according to some embodiments of the present disclosure. FIG. 6 shows operations 71 and 72. In operation 71, the BS 10 may actively determine that coverage interruption may occur. In operation 71, the BS 10 may generate a coverage interruption estimation based on the information stored in the BS 10. Operation 71 may be a part of operation 41.

In operation 72, the BS 10 may transmit a coverage interruption estimation to the BS 20 and/or the core network 40. The coverage interruption estimation transmitted by the BS 10 may be generated by the BS 10 based on the information stored in the BS 10. Operation 72 may be a part of operation 42.

In one embodiment, the network configures the UE 30 to estimate and/or report coverage interruption estimation that may include at least one of the following items: (1) identity of the next serving BS/cell after coverage interruption; (2) an area or location where the network coverage may interrupt (i.e. an area or location where the serving BS/cell may be unavailable); (3) an area or location where the network coverage may restore (i.e. an area or location where the next serving BS/cell may be available); (4) a time when the network coverage may interrupt (i.e. a time when the serving BS/cell may be unavailable); (5) a time when the network coverage may restore (i.e. a time when the next serving BS/cell may be available).

The configuration to the UE 30 may be indicated independently (a dedicated signalling message) or together with existing mechanism including system information, measurement configuration and MDT configuration.

For example, the information element (IE) CoverageInterruptionReportConfig may specify the configuration for a coverage interruption estimation.

```
CoverageInterruptionReportConfig information element
-- ASN1START
Coverage InterruptionReportConfig-r18 : : = SEQUENCE {
  includeCellId-r18 ENUMERATED { true},
  includeLocationInfo-r18 ENUMERATED { true} OPTIONAL,
  includeInterruptionTime-r18 ENUMERATED {true} OPTIONAL,
  report Type CHOICE {
    periodical PeriodicalReportConfig,
    event Triggered Event TriggerConfig,
}
EventTriggerConfig: : = SEQUENCE {
  eventId CHOICE {
      eventI1 SEQUENCE {
        I1-Time INTEGER (n1 . . . n2)
      },
      eventI2 SEQUENCE {
        I2-Location LocationInfo-r10
      },
      eventI3 SEQUENCE {
        I3-Velocity INTEGER (n3 . . . n4)
      },
      eventI4 SEQUENCE {
        I4-Threshold MeasTriggerQuantity
      },
      timeToTrigger TimeToTrigger
    },
  },
},
-- ASN1STOP
```

The coverage interruption estimation and the corresponding transmission may be triggered immediately after reception of configuration, or periodically triggered by a pre-determined or configured periodicity, or triggered by pre-determined or configured events. The trigger conditions may include: (1) a configured time (including a configured periodicity) arrives; (2) the UE is at a configured location or area; (3) the UE's velocity is above or below a configured threshold; and (4) the signal strength received by the UE is above or below a configured threshold.

The coverage interruption estimation may be reported independently (a dedicated signalling message) or together with existing mechanism including measurement report and MDT report.

For example, the IE CoverageInterruptionReport may specify the information related to coverage interruption to be reported.

```
CoverageInterruptionReport information element
-- ASN1START
CoverageInterruptionReportConfig-r18 : : = SEQUENCE {
  cellId PhysCellId,
  locationInfo-r18 LocationInfo-r10 OPTIONAL,
  InterruptionTime INTEGER (n5 . . . n6) OPTIONAL,
}
-- ASN1STOP
```

In another embodiment, the network may prepare a coverage interruption estimation or a coverage restoring information by inter-BS information exchange transmitted through the Xn/X2 interface. The BS 10 may transmit the coverage interruption estimation to the BS 20 as being the estimated next serving BS. The BS 10 may transmit a request to the BS 20 for a coverage restoring information when the BS 20 is the estimated next serving BS. The BS 20 may respond a coverage restoring information to the BS 10. The coverage restoring information may include at least one of the following items: (1) identity of a next serving cell associated with the BS 20; (2) an area or location where a next serving cell associated with the BS 20 may be available; (3) a time when a next serving cell associated with the BS 20 may be available; and (4) other information required to access a next serving cell associated with the BS 20.

The network may prepare a coverage interruption estimation and a coverage restoring information by exchanging information between the BS and corresponding core network entity (e.g., the core network 40). The BS 10 may transmit a request to its corresponding core network entity (e.g., AMF entity or MME) for a coverage restore configuration. The corresponding core network entity may (1) forward request to the BS 20; (2) retain the context of the UE 30 during coverage interruption for coverage restoring; and (3) retains the NAS configuration of the UE 30 (including data flow mapping, configuration of PDU session, EPC bearer, PDN connection) during the coverage interruption for coverage restoring.

In a further embodiment, before coverage interruption occurs, the network (e.g., the BS 10) may transmit a coverage restoring information to the UE 30. The coverage restoring received by the UE 30 may include at least one of following items: (1) identity of the next serving cell; (2) an area or location where a next serving cell may be available; (3) a time when a next serving cell may be available; (4) indication of retaining the configuration (including the current connection configuration between the UE 30 and the BS 10 and the coverage restoring information) when changing states (e.g. IDLE or INACTIVE); and (5) other information required to access a next serving cell.

The coverage restoring information may be transmitted in a RRC signalling message (including RRC reconfiguration, RRC release, and RRC release with suspend). The UE 30 may retain the configuration (including the current connection configuration between the UE 30 and the BS 10 and the coverage restoring information) in CONNECTED state and other states (e.g., IDLE or INACTIVE).

After coverage interruption ends or when the coverage restores, the UE 30 may be triggered to request for restoring the connection using coverage restoring information. The trigger conditions may include at least one of the following:
(1) the time as configured in the coverage restoring information arrives;
(2) the UE 30 is at the location or area as configured in the coverage restoring information;
(3) the UE 30 receives system information from the next serving BS/cell as configured in the coverage restoring information;
(4) the UE 30 selects/reselects the next serving BS/cell as configured in the coverage restoring information; and
(5) the UE 30 is paged by the next serving BS/cell as configured in the coverage restoring information.

The UE can transmit the connection restore request in RRC signalling message including RRC reconfiguration complete/re-establishment/resume. If the UE can pre-compensate the timing advance to the next serving cell e.g., based on the ephemeris information of the next serving satellite, the UE can omit random access procedures to the next serving BS/cell as configured in the coverage restore configuration.

The UE 30 may omit random access if the pre-compensated timing advance is accurate. If the pre-compensated timing advance is not accurate, the network (e.g., the BS 20) may transmit a rejection due to timing misalignment. If the UE 30 receives a rejection from the network (e.g., the BS 20), the UE 30 may fall back to initiating random access and attempt connection after successful random access.

Upon the receipt of the request for restoring the connection request from the UE 30, the next serving BS (e.g., the BS 20) may initiate retrieval for the context of the UE 30 or the status of the previous serving BS (e.g., the BS 10), the next serving BS (e.g., the BS 20) may restore the connection to the UE 30 with coverage restoring information.

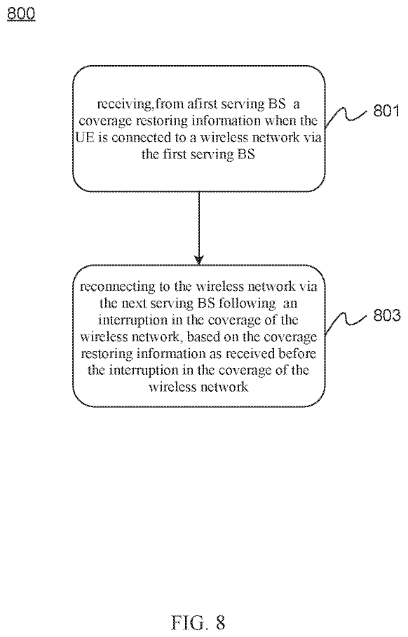

FIG. 8 is a flowchart of a method 800 according to some embodiments of the present disclosure. The method 800 may be performed by a UE. In some embodiments, the UE performing the method 800 may be the UE 30.

In operation 801, the UE may receive, from a first serving base station (BS), a coverage restoring information when the UE is connected to a wireless network via the first serving BS. The coverage restoring information may be associated with a next serving BS, for reconnecting the UE to the wireless network via the next serving BS. The first serving BS may be the current serving BS for the UE. In some embodiments, the UE may retain the coverage restoring information when an interruption in the coverage of the wireless network occurs.

In some embodiment, the coverage restoring configuration may be generated at least partially based on the coverage interruption estimation provided by the UE. In another embodiment, the coverage restoring configuration may be generated based on the coverage interruption estimation provided by the first BS.

In operation 803, the UE may reconnect to the wireless network via the next serving BS following an interruption in the coverage of the wireless network, based on the coverage restoring information as received before the interruption in the coverage of the wireless network. The next serving BS may be the available BS following an interruption in the coverage of the wireless network. The UE may restore the connection related to the first serving BS (i.e., the previously serving BS) with the next serving BS (i.e., the current available BS).

In some embodiments, the method 800 may further comprises transmitting a first coverage interruption estimation associated with the UE and/or the first serving BS, to the first serving BS. The UE may transmit a first coverage interruption estimation to the first serving BS when the UE determines that coverage interruption may occur. The UE may transmit a first coverage interruption estimation to the first serving BS when the UE receive a request and/or a coverage interruption estimation from the first serving BS. When the UE determines that coverage interruption may occur based on a request and/or a coverage interruption estimation from the first serving BS, the UE may transmit a first coverage interruption estimation to the first serving BS.

In some embodiments of the method 800, the first coverage interruption estimation may include at least one of following items:
an identity of a second serving BS;
an identity of a second serving cell associated with a second serving BS;
a location where a coverage of the first serving BS is interrupted;
a location where a coverage of the second serving BS is available;
a time when a coverage of the first serving BS is interrupted; and
a time when a coverage of the second serving BS will be available.
   The second serving BS/cell may be reported or estimated by the UE. The second serving BS/cell reported or estimated by the UE may not be identical to the next serving BS/cell to which the UE connects when the coverage restores.

In some embodiments of the method 800, the first coverage interruption estimation may be based on at least one of following items:
a location of the UE;
a velocity of the UE;
a route of the UE;
information of the first serving BS (e.g., satellite ephemeris);
information of a second serving BS; and
a second coverage interruption estimation received from the first BS.
   The information of the first serving BS may include the satellite ephemeris, the coverage, and the deployment of the first serving BS. The information of the second serving BS may include the satellite ephemeris, the coverage, and the deployment of the second serving BS.

In some embodiments of the method 800, the first coverage interruption estimation may be transmitted to the first serving BS via at least one of the following
RRC signalling for measurement report; and
a minimized drive test (MDT) report.

In some embodiments of the method 800, transmitting the first coverage interruption estimation to the first serving BS may be triggered based on at least one of the conditions that:
a first request for the first coverage interruption estimation is received from the first serving BS (e.g., through a dedicated signalling or broadcasting);
a second coverage interruption estimation is received from the first serving BS; (e.g. through a dedicated signalling or broadcasting);
a pre-determined time or a pre-determined periodicity to transmit the first coverage interruption estimation to the first serving BS arrives;
the UE is at a pre-determined location;
a velocity of the UE is above a pre-determined threshold; and
a signal strength of the first serving BS as received by the UE is below a pre-determined threshold.

In some embodiments of the method 800, the coverage restoring information may include at least one of following items:
an identity of the next serving BS;
an identity of a next serving cell associated with the next serving BS;
a location where a coverage of the first serving BS is interrupted;
a location where a coverage of the next serving BS is available;
a time when a coverage of the first serving BS is interrupted;
a time when a coverage of the next serving BS will be available; and
an indication of retaining current configuration of the UE if the UE is no longer in an RRC_CONNECTED state with the wireless network; and (e.g. changing to IDLE/INACTIVE state); and
information to access the next serving BS.

In some embodiments of the method 800, the coverage restoring information may be received via at least one of the following:
RRC reconfiguration signalling;
RRC release signalling;
RRC release with suspend signalling; and
system information broadcasting.

In some embodiments of the method 800, reconnecting the UE to the wireless network via the next serving BS may be triggered based on at least one of the conditions that:
a predetermined time to reconnect the UE to the wireless network arrives;
the UE is at a location as specified in the coverage restoring information;
the UE receives information from the next serving BS;
the UE selects the next serving BS; and
the UE is paged by the next serving BS.

In some embodiments of the method 800, the UE may transmit a request to reconnect with the wireless network via at least one of the following:
RRC reconfiguration complete signalling;
RRC re-establishment signalling; and
RRC resume signalling.

In some embodiments of the method 800, the UE may reconnect with the wireless network via the next serving BS without needing a random access procedure.

In some embodiments of the method 800, the first serving BS and the next serving BS may be the same. The current serving BS and the next serving BS may be the same BS.

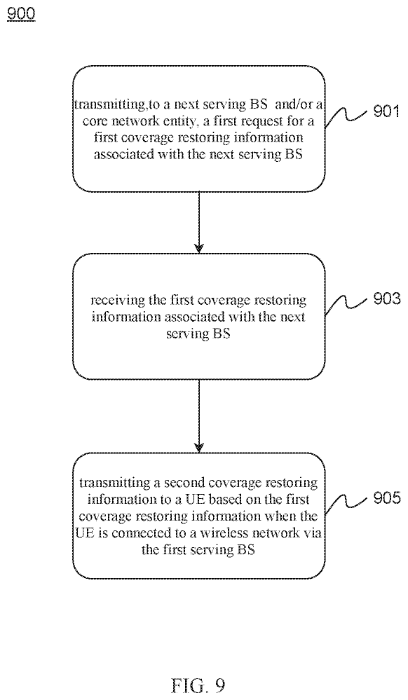

FIG. 9 is a flowchart of a method 900 according to some embodiments of the present disclosure. The method 900 may be performed by a first serving base station (BS). In some embodiments, the first serving BS performing the method 900 may be the BS 10.

In operation 901 of the exemplary method 900 shown in FIG. 9, the first BS may transmit, to a next serving BS and/or a core network entity, a first request for a first coverage restoring information associated with the next serving BS. The transmission to the next serving BS may be through the Xn/X2 interface. The core network entity may be AMF (Access and Mobility Management Function) entity or MME (Mobility Management Entity).

In operation 903, the first serving BS may receive the first coverage restoring information associated with the next serving BS. In operation 905, the first serving BS may transmit a second coverage restoring information to a user equipment (UE) based on the first coverage restoring information when the UE is connected to a wireless network via the first serving BS. The second coverage restoring information may be associated with the next serving BS for reconnecting the UE to the wireless network via the next serving BS. The UE may reconnect to the wireless network following an interruption in a coverage of the wireless network. The first serving BS may be the current serving BS for the UE. In some embodiment, the coverage restoring configuration may be generated at least partially based on the coverage interruption estimation provided by the UE. In another embodiment, the coverage restoring configuration may be generated based on the coverage interruption estimation provided by the first serving BS.

In some embodiments, the method 900 may further comprises transmitting a second request to the core network entity to retain context of the UE and/or non-access stratum configuration of the UE. The first serving BS may request a core network entity to retain UE context and/or UE NAS configuration (e.g., data flow mapping relation, PDU session, EPC bearer, PDN connection) during coverage interruption. The retained UE context and/or UE NAS configuration may be used to restore connection between the UE and the next serving BS.

In some embodiments, the method 900 may further comprises receiving a first coverage interruption estimation associated with the UE and/or the first serving BS, from the UE. The UE may transmit a first coverage interruption estimation to the first serving BS when the UE determines that coverage interruption may occur. The UE may transmit a first coverage interruption estimation to the first serving BS when the UE receive a request or a coverage interruption estimation from the first serving BS. When the UE determines that coverage interruption may occur based on a request or a coverage interruption estimation from the first serving BS, the UE may transmit a first coverage interruption estimation to the first BS.

In some embodiments of the method 900, the first coverage interruption estimation may include at least one of following items:
an identity of a next second serving BS;
an identity of a second serving cell associated with a second serving BS;
a location where a coverage of the first serving BS is interrupted;
a location where a coverage of the second serving BS is available;
a time when a coverage of the first serving BS is interrupted; and
a time when a coverage of the second serving BS will be available.
   The second serving BS/cell may be reported or estimated by the UE. The second serving BS/cell reported or estimated by the UE may not be identical to the next serving BS/cell to which the UE connects when the coverage restores.

In some embodiments of the method 900, the first coverage interruption estimation may be received from the UE via at least one of the following:
RRC signalling for measurement report; and
a minimized drive test (MDT) report.

In some embodiments, the method 900 may further comprises transmitting a third request to the UE, in which the third request is used to request the first coverage interruption estimation from the UE. The method 900 may further comprises transmitting a second coverage interruption estimation to the UE. The UE may transmit the first coverage interruption estimation to the first serving BS when the UE receive a third request and/or a second coverage interruption estimation from the first serving BS. When the UE determines that coverage interruption may occur based on a third request and/or a second coverage interruption estimation from the first serving BS, the UE may transmit the first coverage interruption estimation to the first serving BS.

In some embodiments of the method 900, the first request for the first coverage restoring information is based on a third coverage interruption estimation of the first serving BS. The first coverage restoring configuration may be generated based on a third coverage interruption estimation provided by the first BS.

In some embodiments of the method 900, the first coverage restoring information may include at least one of following items:
an identity of the next serving BS;
an identity of a next serving cell associated with the next serving BS;
a location where a coverage of the first BS is interrupted;
a location where a coverage of the next serving BS is available;
a time when a coverage of the first BS is interrupted;
a time when a coverage of the next serving BS will be available; and
information to access the next serving BS.

In some embodiments of the method 900, the second coverage restoring information may include at least one of following items:
an identity of the next serving BS;
an identity of a next serving cell associated with the next serving BS;
a location where a coverage of the first BS is interrupted;
a location where a coverage of the next serving BS is available;
a time when a coverage of the first BS is interrupted;
a time when a coverage of the next serving BS will be available;
an indication of retaining current configuration of the UE if the UE is no longer in an RRC_CONNECTED state with the wireless network (e.g. changing to IDLE/INACTIVE state); and
information to access the next serving BS.

In some embodiments of the method 900, the second coverage restoring information may be transmitted by the first serving BS via at least one of the following:
RRC reconfiguration signalling;
RRC release signalling;
RRC release with suspend signalling; and
system information broadcasting.

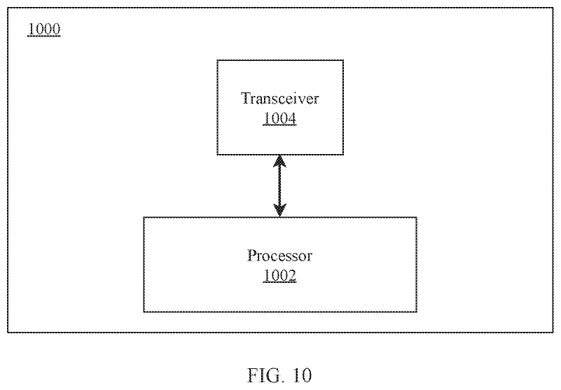

FIG. 10 is a simplified block diagram of an apparatus 1000 according to some embodiments of the present disclosure. The apparatus 1000 may be the UE 30.

Referring to FIG. 10, the apparatus 1000 may include at least one processor 1002, and at least one transceiver 1004. In some embodiments of the present disclosure, at least one transceiver 1004 may implemented as at least one receiver and at least one transmitter. The at least one processor 1002 may be coupled to the transceiver 1004. The at least one processor 1002 may be configured to implement a method with the at least one transceiver 1004. The method may comprises: receiving, via the at least one transceiver, a coverage restoring information from a first serving base station (BS) when the UE is connected to a wireless network via the first serving BS, wherein the coverage restoring information is associated with a next serving BS, for reconnecting the UE to the wireless network via the next serving BS; and reconnect, via the at least one transceiver, to the wireless network through the next serving BS following an interruption in the coverage of the wireless network, based on the coverage restoring information as received before the interruption in the coverage of the wireless network. The method may be a method according to any embodiment of the present disclosure, for example, one of the methods shown in FIGS. 2 to 9.

Referring to FIG. 10 again, the apparatus 1000 may be the BS 10. The at least one processor 1002 may be configured to implement a method with the at least one transceiver 1004. The method may comprises: transmitting, to a second BS and/or a core network entity, a first request for a first coverage restoring information associated with the second BS via the at least one transceiver; receiving the first coverage restoring information associated with the other BS; and transmitting a second coverage restoring information to a user equipment (UE) based on the first coverage restoring information when the UE is connected to a wireless network via the first BS, wherein the second coverage restoring information is associated with the second BS, for reconnecting the UE to the wireless network via the second BS following an interruption in a coverage of the wireless network. The method may be a method according to any embodiment of the present disclosure, for example, one of the methods shown in FIGS. 2-9

Some embodiments of the present disclosure may be disclosed below:

Embodiment 1: A method performed by a user equipment (UE), comprising:
receiving, from a first serving base station (BS), a coverage restoring information when the UE is connected to a wireless network via the first serving BS, wherein the coverage restoring information is associated with a next serving BS, for reconnecting the UE to the wireless network via the next serving BS; and
reconnecting to the wireless network via the next serving BS following an interruption in the coverage of the wireless network, based on the coverage restoring information as received before the interruption in the coverage of the wireless network.
   Embodiment 2: The method of Embodiment 1, further comprising:
transmitting a first coverage interruption estimation associated with the UE and/or the first serving BS, to the first serving BS.
   Embodiment 3: The method of Embodiment 2, wherein the first coverage interruption estimation includes at least one of following items:
an identity of a second serving BS
an identity of a second serving cell associated with a second serving BS;
a location where a coverage of the first serving BS is interrupted;
a location where a coverage of the second serving BS is available;
a time when a coverage of the first serving BS is interrupted; and
a time when a coverage of the second serving BS will be available.
   Embodiment 4: The method of Embodiment 2, wherein the first coverage interruption estimation is based on at least one of following items:
a location of the UE;
a velocity of the UE;
a route of the UE;
information of the first serving BS;
information of a second serving BS; and
a second coverage interruption estimation received from the first BS.
   Embodiment 5: The method of Embodiment 2, wherein the first coverage interruption estimation is transmitted to the first serving BS via at least one of the following:
RRC signalling for measurement report; and
a minimized drive test (MDT) report.
   Embodiment 6: The method of Embodiment 2, wherein transmitting the first coverage interruption estimation to the first serving BS is triggered based on at least one of the conditions that:
a first request for the first coverage interruption estimation is received from the first serving BS;
a second coverage interruption estimation is received from the first serving BS;
a pre-determined time or a pre-determined periodicity to transmit the first coverage interruption estimation to the first serving BS arrives;
the UE is at a pre-determined location;
a velocity of the UE is above a pre-determined threshold; and
a signal strength of the first serving BS as received by the UE is below a pre-determined threshold.
   Embodiment 7: The method of Embodiment 1, wherein the coverage restoring information includes at least one of following items:
an identity of the next serving BS;
an identity of a next serving cell associated with the next serving BS;
a location where a coverage of the first serving BS is interrupted;
a location where a coverage of the next serving BS is available;
a time when a coverage of the first serving BS is interrupted;
a time when a coverage of the next serving BS will be available;
an indication of retaining current configuration of the UE if the UE is no longer in an RRC_CONNECTED state with the wireless network; and
information to access the next serving BS.
   Embodiment 8: The method of Embodiment 1, wherein the coverage restoring information is received from the first serving BS via at least one of the following:
RRC reconfiguration signalling;
RRC release signalling;
RRC release with suspend signalling; and
system information broadcasting.
   Embodiment 9: The method of Embodiment 1, wherein reconnecting the UE to the wireless network via the next serving BS is triggered based on at least one of the conditions that:
a predetermined time to reconnect the UE to the wireless network arrives;
the UE is at a location as specified in the coverage restoring information;
the UE receives information from the next serving BS;
the UE selects the next serving BS; and
the UE is paged by the next serving BS.
   Embodiment 10: The method of Embodiment 1, wherein UE transmits a request to reconnect with the wireless network via at least one of the following:
RRC reconfiguration complete signalling;
RRC re-establishment signalling; and
RRC resume signalling.
   Embodiment 11: The method of Embodiment 1, wherein the UE reconnects with the wireless network via the next serving BS without needing a random access procedure.
   Embodiment 12: The method of Embodiment 1, wherein the first serving BS and the next serving BS are the same.
   Embodiment 13: A method performed by a first serving base station (BS), comprising:
transmitting, to a next serving BS and/or a core network entity, a first request for a first coverage restoring information associated with the next serving BS;
receiving the first coverage restoring information associated with the next serving BS; and
transmitting a second coverage restoring information to a user equipment (UE) based on the first coverage restoring information when the UE is connected to a wireless network via the first serving BS, wherein the second coverage restoring information is associated with the next serving BS for reconnecting the UE to the wireless network via the next serving BS, following an interruption in a coverage of the wireless network.
   Embodiment 14: The method of Embodiment 13, further comprising:
transmitting a second request to the core network entity to retain context of the UE and/or non-access stratum configuration of the UE.
   Embodiment 15: The method of Embodiment 13, further comprising:
receiving a first coverage interruption estimation associated with the UE and/or the first serving BS, from the UE.
   Embodiment 16: The method of Embodiment 15, wherein the first coverage interruption estimation includes at least one of following items:
an identity of a second serving BS;
an identity of a second serving cell associated with a second serving BS;
a location where a coverage of the first serving BS is interrupted;
a location where a coverage of the second serving BS is available;
a time when a coverage of the first serving BS is interrupted; and
a time when a coverage of the second serving BS will be available.
   Embodiment 17: The method of Embodiment 15, wherein the first coverage interruption estimation is received from the UE via at least one of the following:
RRC signalling for measurement report; and
a minimized drive test (MDT) report.
   Embodiment 18: The method of Embodiment 15, further comprising:
transmitting a third request for the first coverage interruption estimation to the UE; and/or
transmitting a second coverage interruption estimation to the UE.
   Embodiment 19: The method of Embodiment 13, wherein the first request for the first coverage restoring information is based on a third coverage interruption estimation of the first serving BS.
   Embodiment 20: The method of Embodiment 13, wherein the first coverage restoring information includes at least one of following items:
an identity of the next serving BS;
an identity of a next serving cell associated with the next serving BS;
a location where a coverage of the first BS is interrupted;
a location where a coverage of the next serving BS is available;
a time when a coverage of the first BS is interrupted;
a time when a coverage of the next serving BS will be available; and
information to access the next serving BS.
   Embodiment 21: The method of Embodiment 13, wherein the second coverage restoring information includes at least one of following items:
an identity of the next serving BS;
an identity of a next serving cell associated with the next serving BS;
a location where a coverage of the first BS is interrupted;
a location where a coverage of the next serving BS is available;
a time when a coverage of the first BS is interrupted;
a time when a coverage of the next serving BS will be available;
an indication of retaining current configuration of the UE if the UE is no longer in an RRC_CONNECTED state with the wireless network; and
information to access the next serving BS.
   Embodiment 22: The method of Embodiment 13, wherein the second coverage restoring information is transmitted by the first serving BS via at least one of the following:
RRC reconfiguration signalling;
RRC release signalling;
RRC release with suspend signalling; and
system information broadcasting.
   Embodiment 23: A user equipment (UE), comprising:
at least one processor; and
at least one transceiver coupled to the at least one processor;
wherein the at least one processor is configured to
   receive, via the at least one transceiver, a coverage restoring information from a first serving base station (BS) when the UE is connected to a wireless network via the first serving BS, wherein the coverage restoring information is associated with a next serving BS, for reconnecting the UE to the wireless network via the next serving BS; and
   reconnect, via the at least one transceiver, to the wireless network through the next serving BS following an interruption in the coverage of the wireless network, based on the coverage restoring information as received before the interruption in the coverage of the wireless network.
      Embodiment 24: A first base station (BS), comprising:
at least one processor; and
at least one transceiver coupled to the at least one processor;
wherein the at least one processor is configured to:
   transmit, to a second BS and/or a core network entity, a first request for a first coverage restoring information associated with the second BS via the at least one transceiver;
   receive the first coverage restoring information associated with the other BS; and
   transmit a second coverage restoring information to a user equipment (UE) based on the first coverage restoring information when the UE is connected to a wireless network via the first BS, wherein the second coverage restoring information is associated with the second BS, for reconnecting the UE to the wireless network via the second BS following an interruption in a coverage of the wireless network.

The method according to embodiments of the present disclosure can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present disclosure provides an apparatus for connection restoring in a non-terrestrial network, including a processor and a memory. Computer programmable instructions for implementing a method for connection restoring in a non-terrestrial network are stored in the memory, and the processor is configured to perform the computer programmable instructions to implement the method for emotion recognition from speech. The method may be a method as stated above or other method according to an embodiment of the present disclosure.

An alternative embodiment preferably implements the methods according to embodiments of the present disclosure in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor, but the instructions may alternatively or additionally be executed by any suitable dedicated hardware device. For example, an embodiment of the present disclosure provides a non-transitory, computer-readable storage medium having computer programmable instructions stored therein. The computer programmable instructions are configured to implement a method for emotion recognition from speech as stated above or other method according to an embodiment of the present disclosure.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A method performed by a user equipment (UE), the UE comprising:
receiving, from a first serving base station (BS) when the UE is connected to a wireless network via the first serving BS, a coverage restoring information that is associated with a next serving BS and that is for reconnecting the UE to the wireless network via the next serving BS; and
reconnecting, based on the coverage restoring information as received before an interruption in the coverage of the wireless network, to the wireless network via the next serving BS following the interruption in the coverage of the wireless network.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A first serving base station (BS) for wireless communication, comprising:
at least one memory; and
at least one processor coupled with the at least one memory and configured to cause the first serving BS to:
transmit, to one or both of a next serving BS and a core network entity, a first request for a first coverage restoring information associated with the next serving BS;
receive the first coverage restoring information associated with the next serving BS; and
transmit a second coverage restoring information to a user equipment (UE) based on the first coverage restoring information when the UE is connected to a wireless network via the first serving BS, the second coverage restoring information being associated with the next serving BS for reconnecting the UE to the wireless network via the next serving BS following an interruption in a coverage of the wireless network.

14. (canceled)

15. A user equipment (UE) for wireless communication, comprising:
at least one memory; and
at least one processor coupled with the at least one memory and configured to cause the UE to:
receive, from a first serving base station (BS) when the UE is connected to a wireless network via the first serving BS, a coverage restoring information that is associated with a next serving BS and that is for reconnecting the UE to the wireless network via the next serving BS; and
reconnect, based on the coverage restoring information as received before an interruption in the coverage of the wireless network, to the wireless network via the next serving BS following the interruption in the coverage of the wireless network.

16. The UE of claim 15, wherein the at least one processor is configured to cause the UE to:
transmit, to the first serving BS, a first coverage interruption estimation associated with one or both of the UE or the first serving BS.

17. The UE of claim 16, wherein the first coverage interruption estimation includes at least one of:
an identity of a second serving BS;
an identity of a second serving cell associated with the second serving BS;
a location where a coverage of the first serving BS is interrupted;
a location where a coverage of the second serving BS is available;
a time when a coverage of the first serving BS is interrupted; and
a time when a coverage of the second serving BS will be available.

18. The UE of claim 16, wherein the first coverage interruption estimation is based on at least one of:
a location of the UE;
a velocity of the UE;
a route of the UE;
information of the first serving BS;
information of a second serving BS; and
a second coverage interruption estimation received from the first serving BS.

19. The UE of claim 16, wherein the first coverage interruption estimation is transmitted to the first serving BS via at least one of:
RRC signalling for measurement report; and
a minimized drive test (MDT) report.

20. The UE of claim 16, wherein transmission of the first coverage interruption estimation to the first serving BS is triggered based on at least one of multiple conditions that include:
a first request for the first coverage interruption estimation is received from the first serving BS;
a second coverage interruption estimation is received from the first serving BS;
a pre-determined time or a pre-determined periodicity to transmit the first coverage interruption estimation to the first serving BS arrives;
the UE is at a pre-determined location;
a velocity of the UE is above a pre-determined threshold; and
a signal strength of the first serving BS as received by the UE is below a pre-determined threshold.

21. The UE of claim 15, wherein the coverage restoring information includes at least one of:
an identity of the next serving BS;
an identity of a next serving cell associated with the next serving BS;
a location where a coverage of the first serving BS is interrupted;
a location where a coverage of the next serving BS is available;
a time when a coverage of the first serving BS is interrupted;
a time when a coverage of the next serving BS will be available;
an indication of retaining current configuration of the UE if the UE is no longer in an RRC_CONNECTED state with the wireless network; and
information to access the next serving BS.

22. The UE of claim 15, wherein the coverage restoring information is received from the first serving BS via at least one of:
RRC reconfiguration signalling;
RRC release signalling;
RRC release with suspend signalling; and
system information broadcasting.

23. The UE of claim 15, wherein reconnecting the UE to the wireless network via the next serving BS is triggered based on at least one of multiple conditions that include:
a predetermined time to reconnect the UE to the wireless network arrives;
the UE is at a location as specified in the coverage restoring information;
the UE receives information from the next serving BS;
the UE selects the next serving BS; and
the UE is paged by the next serving BS.

24. The UE of claim 15, wherein the at least one processor is configured to cause the UE to transmit a request to reconnect with the wireless network via at least one of:
RRC reconfiguration complete signalling;
RRC re-establishment signalling; and
RRC resume signalling.

25. The UE of claim 15, wherein the ULE reconnects with the wireless network via the next serving BS without needing a random access procedure.

26. The UE of claim 15, wherein the first serving BS and the next serving BS are a same BS.

27. A processor for wireless communication, comprising:
at least one controller coupled with at least one memory and configured to cause the processor to:
receive, from a first serving base station (BS) when a user equipment (UE) that includes the processor is connected to a wireless network via the first serving BS, a coverage restoring information that is associated with a next serving BS and that is for reconnecting the UE to the wireless network via the next serving BS; and
reconnect, based on the coverage restoring information as received before an interruption in the coverage of the wireless network, to the wireless network via the next serving BS following the interruption in the coverage of the wireless network.

28. The processor of claim 27, wherein the at least one controller is configured to cause the processor to:
transmit, to the first serving BS, a first coverage interruption estimation associated with one or both of the UE or the first serving BS.

29. The processor of claim 27, wherein the coverage restoring information includes at least one of:
an identity of the next serving BS;
an identity of a next serving cell associated with the next serving BS;
a location where a coverage of the first serving BS is interrupted;
a location where a coverage of the next serving BS is available;
a time when a coverage of the first serving BS is interrupted;
a time when a coverage of the next serving BS will be available;
an indication of retaining current configuration of the UE if the UE is no longer in an RRC_CONNECTED state with the wireless network; and
information to access the next serving BS.

30. The processor of claim 27, wherein the coverage restoring information is received from the first serving BS via at least one of:
RRC reconfiguration signalling;
RRC release signalling;
RRC release with suspend signalling; and
system information broadcasting.

31. The processor of claim 27, wherein reconnecting the UE to the wireless network via the next serving BS is triggered based on at least one of multiple conditions that include:
a predetermined time to reconnect the UE to the wireless network arrives;
the UE is at a location as specified in the coverage restoring information;
the UE receives information from the next serving BS;
the UE selects the next serving BS; and
the UE is paged by the next serving BS.

32. The processor of claim 27, wherein the at least one controller is configured to cause the processor to transmit a request to reconnect with the wireless network via at least one of:
RRC reconfiguration complete signalling;
RRC re-establishment signalling; and
RRC resume signalling.
